(19) United States
(12) Patent Application Publication
(10) Pub. No.: US 2015/0354713 A1
(43) Pub. Date: Dec. 10, 2015

(54) Five-Way Heat Pump Reversing Valve

(71) Applicant: Trane International Inc., Piscataway, NJ (US)

(72) Inventor: Stephen Stewart Hancock, Flint, TX (US)

(21) Appl. No.: 14/720,170

(22) Filed: May 22, 2015

Related U.S. Application Data
(60) Provisional application No. 62/010,245, filed on Jun. 10, 2014.

(51) Int. Cl. F16K 11/06; F25B 13/00; F16K 49/00

(52) U.S. Cl. CPC F16K 11/06; F16K 49/00; F25B 13/00; F25B 2313/0292; F25B 2313/027

(57) ABSTRACT

Systems and methods are disclosed which may include providing a five-way reversing valve in a heat pump HVAC system, wherein the five-way reversing valve comprises a selectively movable shuttle, a first high pressure inlet port, a second high pressure inlet port, a first variable port, a first outlet port, and a second variable port, and wherein the five-way reversible valve is configured to selectively alter a flowpath of refrigerant through the reversing valve between a first operational position associated with a cooling mode and a second operational position associated with a heating mode. The five-way reversing valve may also be configured to remove a component from the refrigerant fluid circuit when configured for operation in one of its two modes of operation.

### CROSS-REFERENCE TO RELATED APPLICATIONS

The present application claims priority under 35 U.S.C. 119(e) to U.S. Provisional Patent Application No. 62/010,245 filed on Jun. 10, 2014 by Stephen Stewart Hancock and entitled “Five-Way Heat Pump Reversing Valve,” the disclosure of which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Heating, ventilation, and/or air conditioning (HVAC) systems may generally be used in residential and/or commercial structures to provide heating and/or cooling to climate-controlled areas within these structures. Some HVAC systems may be heat pump systems that include both an indoor unit and an outdoor unit and that are selectively operable between a cooling mode of operation and a heating mode of operation. Typically, heat pump HVAC systems utilize a reversing valve to selectively control the mode of operation of the heat pump system. Traditional reversing valves used in heat pump systems are generally four-way valves having a single high pressure inlet port connected to the compressor discharge, a single low pressure outlet port connected to the compressor suction, a port connected to the indoor heat exchanger, and a port connected to the outdoor heat exchanger. These traditional four-way reversing valves limit system design flexibility and often introduce various performance losses into the heat pump system.

### SUMMARY

In some embodiments of the disclosure, a reversing valve is disclosed as comprising a selectively movable shuttle, a first high pressure inlet port, a second high pressure inlet port, a first variable port, a first outlet port, and a second variable port.

In other embodiments of the disclosure, an HVAC system is disclosed as comprising a reversing valve comprising a selectively movable shuttle, a first high pressure inlet port, a second high pressure inlet port, a first variable port, a first outlet port, and a second variable port.

In yet other embodiments of the disclosure, a method of operating an HVAC system is disclosed as comprising: providing a reversing valve comprising a selectively movable shuttle, a first high pressure inlet port, a second high pressure inlet port, a first variable port, a first outlet port, and a second variable port in an HVAC system; selectively positioning the shuttle in a first operational position to form a first fluid flowpath from the first variable port to the first outlet port and a second fluid flowpath from the second inlet port to the second variable port; selectively adjusting the position of the shuttle in the reversing valve; and positioning the shuttle in a second operational position to form a first alternative fluid flowpath from the second variable port to the first outlet port and a second alternative fluid flowpath from the first inlet port to the first variable port.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a schematic diagram of an HVAC system comprising a five-way reversing valve and configured in a cooling mode according to an embodiment of the disclosure;

FIG. 2 is a schematic diagram of the HVAC system of FIG. 1 comprising the five-way reversing valve of FIG. 1 and configured in a heating mode according to an embodiment of the disclosure;

FIG. 3 is a schematic diagram of the five-way reversing valve of FIGS. 1-2 configured for operation in the cooling mode according to an embodiment of the disclosure;

FIG. 4 is a schematic diagram of the five-way reversing valve of FIGS. 1-2 configured for operation in the heating mode according to an embodiment of the disclosure;

FIG. 5 is a schematic diagram of a five-way reversing valve configured in the cooling mode according to another embodiment of the disclosure;

FIG. 6 is a flowchart of a method of operating an HVAC system according to an embodiment of the disclosure;

FIG. 7 is a schematic diagram of a five-way reversing valve configured in the cooling mode according to yet another embodiment of the disclosure;

FIG. 8 is a schematic diagram of a five-way reversing valve configured in the heating mode according to yet another embodiment of the disclosure;

FIG. 9 is a schematic diagram of an HVAC system comprising a five-way reversing valve and configured in a cooling mode according to an alternative embodiment of the disclosure;

FIG. 10 is a schematic diagram of the HVAC system of FIG. 9 comprising the five-way reversing valve of FIG. 9 and configured in a heating mode according to an alternative embodiment of the disclosure;

FIG. 11 is a schematic diagram of the five-way reversing valve of FIGS. 9-10 configured for operation in the cooling mode according to an alternative embodiment of the disclosure; and

FIG. 12 is a schematic diagram of the five-way reversing valve of FIGS. 9-10 configured for operation in the heating mode according to an alternative embodiment of the disclosure.

### DETAILED DESCRIPTION

In some cases, it may be desirable to provide a five-way reversing valve in a heat pump HVAC system. For example, in high efficiency heat pump systems comprising both an indoor and an outdoor unit, where the outdoor coil of the outdoor unit is often much larger than the indoor coil of the indoor unit and capable of holding a larger volume of refrigerant, it may be desirable to provide a five-way reversing valve to accommodate additional components that may improve cooling performance when the heat pump system is operated in a cooling mode and that may be used to sequester excess liquid refrigerant during operation of the heat pump system in a heating mode. Additionally, by providing a five-way reversing valve in a heat pump system, design flexibility may be improved, additional functionality and/or additional components may be added to an otherwise traditional heat pump system, which may increase the performance of the heat pump system while still providing the traditional operation of a reversing valve to selectively control the mode of operation of the heat pump system between a cooling mode and a heating mode. In some embodiments, systems and methods are disclosed that comprise providing a five-way reversing valve in an outdoor unit of a heat pump system that accommodates additional components which may be used to increase performance of the heat pump system.

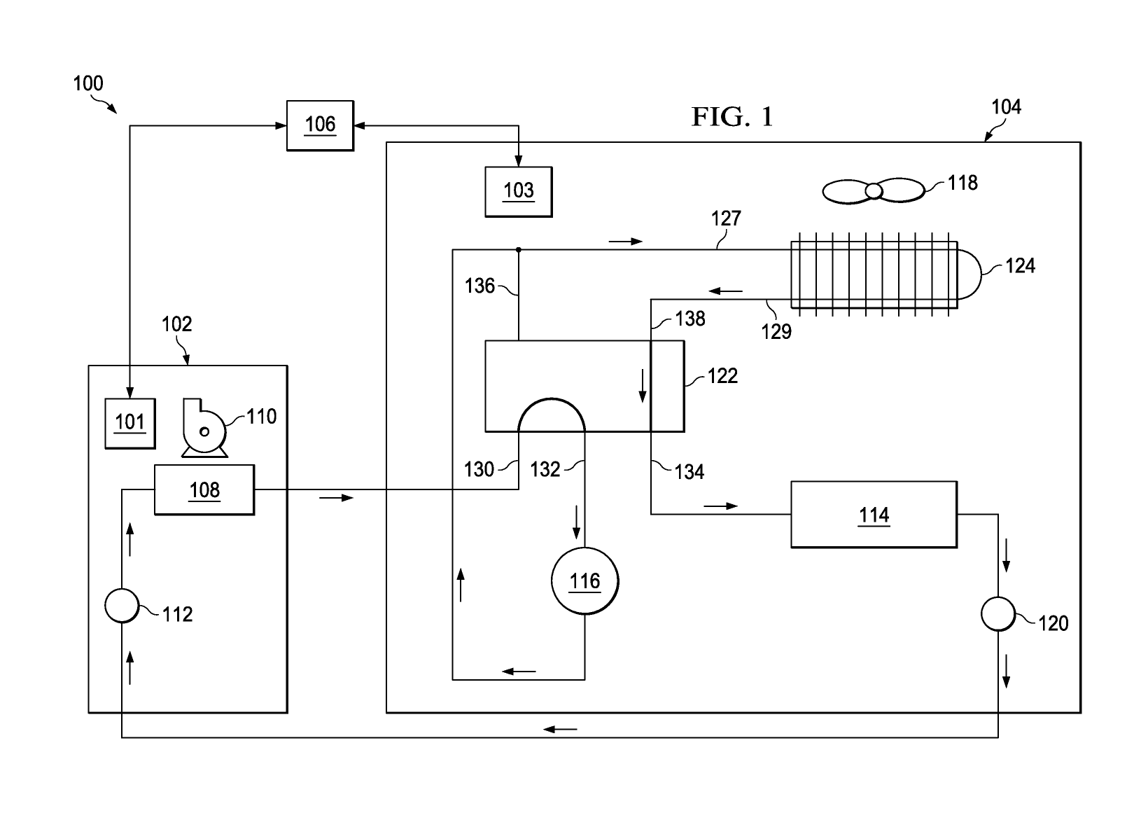

Referring now to FIG. 1, a schematic diagram of an HVAC system 100 comprising a five-way reversing valve 122 is shown configured in a cooling mode according to an embodiment of the disclosure. Most generally, HVAC system 100 comprises a heat pump system that may be selectively operated to implement one or more substantially closed thermodynamic refrigeration cycles to provide a cooling functionality (hereinafter, “cooling mode”) and/or a heating functionality (hereinafter, “heating mode”). Most generally, HVAC system 100, configured as a heat pump system, generally comprises an indoor unit 102, an outdoor unit 104, and a system controller 106.

The system controller 106 may generally be configured to selectively communicate with an indoor controller 101 of the indoor unit 102, an outdoor controller 103 of the outdoor unit 104 and/or other components of the HVAC system 100. In some embodiments, the system controller 106 may be configured to control operation of the indoor unit 102 and/or the outdoor unit 104. Additionally, in some embodiments, the system controller 106 may comprise a temperature sensor and/or may further be configured to control heating and/or cooling of zones associated with the HVAC system 100. In other embodiments, however, the system controller 106 may be configured as a thermostat for controlling the supply of conditioned air to zones associated with the HVAC system 100.

Indoor unit 102 generally comprises an indoor heat exchanger 108, an indoor fan 110, and an indoor metering device 112. In some embodiments, the indoor unit 102 may also comprise an indoor controller 101. The indoor controller 101 may generally be configured to receive information inputs, transmit information outputs, and/or otherwise communicate with the system controller 106 and/or the outdoor controller 103. In some embodiments, the indoor controller 101 may be configured to transmit and/or receive information related to the indoor heat exchanger 108, the indoor fan 110, and/or the indoor metering device 112. Indoor heat exchanger 108 may generally be configured to promote heat exchange between refrigerant carried within internal tubing of the indoor heat exchanger 108 and an airflow that may contact the indoor heat exchanger 108 but that is segregated from the refrigerant. In some embodiments, indoor heat exchanger 108 may comprise a plate-fin heat exchanger. However, in other embodiments, indoor heat exchanger 108 may comprise a spine fin heat exchanger, a microchannel heat exchanger, or any other suitable type of heat exchanger.

The indoor fan 110 may generally comprise a centrifugal blower comprising a blower housing, a blower impeller at least partially disposed within the blower housing, and a blower motor configured to selectively rotate the blower impeller. The indoor fan 110 may generally be configured to provide airflow through the indoor unit 102 and/or the indoor heat exchanger 108 to promote heat transfer between the airflow and a refrigerant flowing through the indoor heat exchanger 108. The indoor fan 110 may also be configured to deliver temperature and/or humidity-conditioned air from the indoor unit 102 to one or more areas and/or zones of a climate controlled structure. The indoor fan 110 may generally comprise a mixed-flow fan and/or any other suitable type of fan. The indoor fan 110 may generally be configured as a modulating and/or variable speed fan capable of being operated at many speeds over one or more ranges of speeds. In other embodiments, the indoor fan 110 may be configured as a multiple speed fan capable of being operated at a plurality of operating speeds by selectively electrically powering different ones of multiple electromagnetic windings of a motor of the indoor fan 110. In yet other embodiments, however, the indoor fan 110 may be a single speed fan.

The indoor metering device 112 may generally comprise an electronically-controlled motor driven electronic expansion valve (EEV). In some embodiments, however, the indoor metering device 112 may comprise a thermostatic expansion valve, a capillary tube assembly, and/or any other suitable metering device. In some embodiments, while the indoor metering device 112 may be configured to meter the volume and/or flow rate of refrigerant through the indoor metering device 112, the indoor metering device 112 may also comprise and/or be associated with a refrigerant check valve and/or refrigerant bypass configuration when the direction of refrigerant flow through the indoor metering device 112 is such that the indoor metering device 112 is not intended to meter or otherwise substantially restrict flow of the refrigerant through the indoor metering device 112.

Outdoor unit 104 generally comprises an outdoor heat exchanger 114, a compressor 116, an outdoor fan 118, an outdoor metering device 120, a reversing valve 122, and a desuperheater heat exchanger 124. In some embodiments, the outdoor unit 104 may also comprise an outdoor controller 103. The outdoor controller 103 may be carried by the outdoor unit 104 and may be configured to receive information inputs, transmit information outputs, and/or otherwise communicate with the system controller 106 and/or the indoor controller 101. In some embodiments, the outdoor controller 103 may be configured to transmit and/or receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116. In some embodiments, the outdoor controller 103 may be configured to transmit information related to monitoring, communicating with, and/or otherwise affecting control over the outdoor fan 118, a solenoid of the reversing valve 122, a relay associated with adjusting and/or monitoring a refrigerant charge of the HVAC system 100, a position of the indoor metering device 112, and/or a position of the outdoor metering device 120.

The outdoor heat exchanger 114 may generally be configured to promote heat transfer between a refrigerant carried within internal passages of the outdoor heat exchanger 114 and an airflow that contacts the outdoor heat exchanger 114 but that is segregated from the refrigerant. In some embodiments, outdoor heat exchanger 114 may comprise a plate-fin heat exchanger. However, in other embodiments, outdoor heat exchanger 114 may comprise a spine-fin heat exchanger, a microchannel heat exchanger, or any other suitable type of heat exchanger.

The compressor 116 may generally comprise a multiple speed scroll-type compressor that may generally be configured to selectively pump refrigerant at a plurality of mass flow rates through the indoor unit 102, the outdoor unit 104, and/or between the indoor unit 102 and the outdoor unit 104. In some embodiments, however, the compressor 116 may comprise a modulating compressor that is capable of operation over a plurality of speed ranges, a reciprocating-type compressor, a single speed compressor, and/or any other suitable refrigerant compressor and/or refrigerant pump.

The outdoor fan 118 may generally comprise an axial fan comprising a fan blade assembly and fan motor configured to selectively rotate the fan blade assembly. The outdoor fan 118 may generally be configured to provide airflow through the outdoor unit 104 and/or the outdoor heat exchanger 114 to promote heat transfer between the airflow and a refrigerant flowing through the indoor heat exchanger 108. In some embodiments, and as will be discussed later herein, the outdoor fan 118 may also be configured to provide airflow through a desuperheater heat exchanger 124. The outdoor fan 118 may generally be configured as a modulating and/or variable speed fan capable of being operated at a plurality of speeds over a plurality of speed ranges. In other embodiments, the outdoor fan 118 may be configured as a multiple speed fan capable of being operated at a plurality of operating speeds by selectively electrically powering different multiple electromagnetic windings of a motor of the outdoor fan 118. In yet other embodiments, the outdoor fan 118 may be a single speed fan. Further, in other embodiments, however, the outdoor fan 118 may comprise a mixed-flow fan, a centrifugal blower, and/or any other suitable type of fan and/or blower.

The outdoor metering device 120 may generally comprise a thermostatic expansion valve. In some embodiments, however, the outdoor metering device 120 may comprise an electronically-controlled motor driven EEV similar to indoor metering device 112, a capillary tube assembly, and/or any other suitable metering device. In some embodiments, while the outdoor metering device 120 may be configured to meter the volume and/or flow rate of refrigerant through the outdoor metering device 120, the outdoor metering device 120 may also comprise and/or be associated with a refrigerant check valve and/or refrigerant bypass configuration when the direction of refrigerant flow through the outdoor metering device 120 is such that the outdoor metering device 120 is not intended to meter or otherwise substantially restrict flow of the refrigerant through the outdoor metering device 120.

The reversing valve 122 may generally comprise a five-way reversing valve. As opposed to a traditional four-way reversing valve, reversing valve 122 generally comprises two high pressure inlet ports: a first inlet port 136 and a second inlet port 138, which, in some embodiments, may enable the reversing valve 122 to be configured to allow refrigerant to enter the reversing valve 122 from alternating high pressure sources. The reversing valve 122 also comprises a first variable port 130, a first outlet port 132, and a second variable port 134. As will be discussed later herein, the reversing valve 122 may generally be selectively controlled to alter a flowpath of refrigerant in the HVAC system 100 by selectively altering a refrigerant flowpath through the first inlet port 136, the second inlet port 138, the first variable port 130, the first outlet port 132, and the second variable port 134. The reversing valve 122 may also comprise an electrical solenoid, relay, and/or other device configured to selectively move a component of the reversing valve 122 between operational positions to alter the flowpaths through the reversing valve 122 and consequently the HVAC system 100. Additionally, the reversing valve 122 may be selectively controlled by the system controller 106 and/or an outdoor controller 103.

The desuperheater heat exchanger 124 may generally be described as comprising a desuperheater inlet 127 and a desuperheater outlet 129. The desuperheater inlet 127 may generally be selectively connected in fluid communication with a discharge side of the compressor 116 and the first inlet port 136 of the reversing valve 122, while the desuperheater outlet 129 may be connected in fluid communication with the second inlet port 138 of the reversing valve 122. When the HVAC system 100 is operated in the cooling mode, the desuperheater heat exchanger 124 may generally be configured to promote heat transfer between a refrigerant carried within internal passages of the desuperheater heat exchanger 124 and an airflow that contacts the desuperheater heat exchanger 124 but that is segregated from the refrigerant. However, when the HVAC system 100 is operated in the heating mode, the desuperheater heat exchanger 124 may, in conjunction with the reversing valve 122, perform the function of a traditional charge robber to store excess liquid refrigerant. In some embodiments, desuperheater heat exchanger 124 may comprise a plate-fin heat exchanger. However, in other embodiments, desuperheater heat exchanger 124 may comprise a spine-fin heat exchanger, a microchannel heat exchanger, or any other suitable type of heat exchanger.

Still referring to FIG. 1, the HVAC system 100 is shown configured for operating in a cooling mode. When the HVAC system 100 is operated in the cooling mode, heat may generally be absorbed by refrigerant at the indoor heat exchanger 108 and rejected from the refrigerant at the outdoor heat exchanger 114 and/or the desuperheater heat exchanger 124. Starting at the compressor 116, the compressor 116 may be operated to compress refrigerant and pump the relatively high temperature and high pressure refrigerant to the desuperheater inlet 127. In this embodiment, and when the HVAC system 100 is operated in the cooling mode, the reversing valve 122 may be configured such that refrigerant flow from the compressor 116 does not enter the first inlet port 136 of the reversing valve 122 and flow through the reversing valve 122. The compressor 116 instead delivers refrigerant to the desuperheater heat exchanger 124 through the first inlet port 136, where the refrigerant may flow through the desuperheater heat exchanger 124.

Within the desuperheater heat exchanger 124, the relatively high temperature refrigerant may transfer heat to an airflow passed through and/or into contact with the desuperheater heat exchanger 124 by the outdoor fan 118. After passing through the desuperheater heat exchanger 124, refrigerant may exit the desuperheater heat exchanger 124 through the desuperheater outlet 129 and flow to the second inlet port 138 of the reversing valve 122. The reversing valve 122 may be configured to allow refrigerant to enter the reversing valve 122 through the second inlet port 138, flow through the reversing valve 122, and exit the reversing valve 122 through the second variable port 134. In some embodiments, when the HVAC system 100 is configured in the cooling mode of operation, the flowpath through the reversing valve 122 from the second inlet port 138 to the second variable port 134 may comprise a substantially straight, linear flowpath, which may, in some embodiments, reduce a pressure drop through the reversing valve 122 and/or provide an increase in efficiency of the HVAC system 100 over a reversing valve having a substantially non-linear flowpath.

Refrigerant exiting the reversing valve 122 through the second variable port 134 may flow to the outdoor heat exchanger 114, where the refrigerant may transfer additional heat to the airflow that is passed through and/or into contact with the outdoor heat exchanger 114 by the outdoor fan 118, thereby condensing to a subcooled liquid-phase refrigerant before exiting the outdoor heat exchanger 114 and flowing to the outdoor metering device 120. By passing the heated refrigerant through the desuperheater heat exchanger 124 prior to passing the refrigerant through the outdoor heat exchanger 114 and by contacting the outdoor heat exchanger 114 with an ambient airflow generated by the outdoor fan 118 prior to the heated airflow encountering the relatively higher temperature desuperheater heat exchanger 124, the temperature differentials between the airflow generated by the outdoor fan 118 and the respective heat exchangers 124, 214 may be maximized. Accordingly, the desuperheater heat exchanger 124 may increase cooling performance and/or the efficiency of the HVAC system 100 as compared to a traditional system that may not comprise a desuperheater heat exchanger 124.

After exiting the outdoor heat exchanger 114, the refrigerant may flow through and/or bypass the outdoor metering device 120, such that refrigerant flow is not substantially restricted by the outdoor metering device 120. Refrigerant generally exits the outdoor metering device 120 and flows to the indoor metering device 112, which may meter the flow of refrigerant through the indoor metering device 112, such that the refrigerant downstream of the indoor metering device 112 is at a lower pressure than the refrigerant upstream of the indoor metering device 112. The pressure differential across the indoor metering device 112 allows the refrigerant downstream of the indoor metering device 112 to expand and/or at least partially convert to a two-phase (vapor and gas) mixture. From the indoor metering device 112, the two-phase refrigerant may enter the indoor heat exchanger 108. As the refrigerant is passed through the indoor heat exchanger 108, heat may be transferred to the refrigerant from an airflow that is passed through and/or into contact with the indoor heat exchanger 108 by the indoor fan 110, thereby causing evaporation of the liquid-phase portion of the two-phase refrigerant mixture. The refrigerant may exit the indoor heat exchanger 108 and flow to the first variable port 130 of the reversing valve 122. In the cooling mode, the reversing valve 122 may be selectively configured to divert the refrigerant back to the compressor 116 through the first outlet port 132. At the compressor 116, the compressor 116 may again increase the pressure of the refrigerant and the refrigeration cycle may begin again.

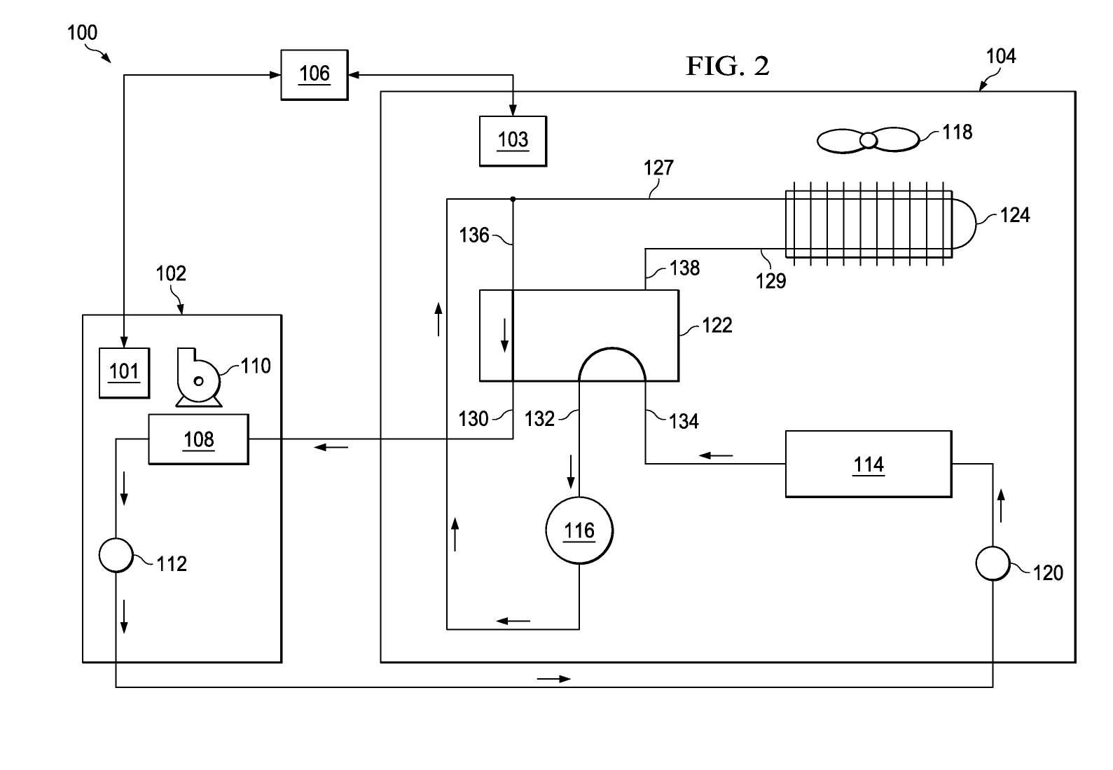

Referring now to FIG. 2, a schematic diagram of the HVAC system 100 of FIG. 1 is shown configured in a heating mode according to an embodiment of the disclosure. When the HVAC system 100 is operated in the heating mode, heat may generally be absorbed by refrigerant at the outdoor heat exchanger 114 and rejected from the refrigerant at the indoor heat exchanger 108. Further, in some embodiments, switching to a heating mode may cause a component of the reversing valve 122 to selectively configure the reversing valve 122 to divert refrigerant through alternative flowpaths than when the reversing valve 122 is configured in the cooling mode. Starting at the compressor 116, the compressor 116 may similarly be operated to compress refrigerant and pump the relatively high temperature and high pressure compressed refrigerant to the first inlet port 136 of the reversing valve 122. While the discharge of the compressor 116 remains in fluid communication with the desuperheater heat exchanger 124, the reversing valve 122 may be selectively configured to prevent refrigerant from passing through the reversing valve 122 via the second inlet port 138. As a result, substantially no refrigerant passes through the desuperheater heat exchanger 124 during operation of the HVAC system 100 in the heating mode. Thus, when the HVAC system 100 is operated in the heating mode, the desuperheater heat exchanger 124 remains functionally idle with respect to refrigerant flow. However, the desuperheater heat exchanger 124 may be configured to sequester excess refrigerant that is not needed for a heating operation in HVAC system 100. Therefore, the desuperheater heat exchanger 124 may perform the function of a traditional charge robber in the heating mode by sequestering excess liquid refrigerant that traditionally may backup in the indoor heat exchanger 108 and reduce the efficiency of the HVAC system 100.

Additionally, as a result of the location of the desuperheater heat exchanger 124 in the refrigeration circuit, the desuperheater heat exchanger 124 may sequester excess liquid refrigerant at a location that is as far upstream from the compressor 116 as possible. Accordingly, the desuperheater heat exchanger 124 may prevent excess liquid refrigerant that poses a potential damage risk to the compressor 116 from entering the compressor 116, thereby increasing the reliability of the compressor 116 and/or preventing damage to the compressor 116. Further, in addition to increasing the cooling performance and/or efficiency of the HVAC system 100 when the HVAC system 100 is operated in the cooling mode, the desuperheater heat exchanger 124 may improve heating performance by performing the function of a traditional charge robber by sequestering the excess liquid refrigerant without the additional cost and complexity of adding a traditional charge robbing system.

Continuing through the heating cycle, refrigerant entering the first inlet port 136 of the reversing valve 122 may flow through the reversing valve and exit the reversing valve 122 via the first variable port 130. The high temperature refrigerant may then flow to the indoor heat exchanger 108 where it may transfer heat to an airflow that is passed through and/or into contact with the indoor heat exchanger 108 by the indoor fan 110. After exiting the indoor heat exchanger 108, the refrigerant may flow through and/or bypass the indoor metering device 112, such that refrigerant flow is not substantially restricted by the indoor metering device 112. Refrigerant generally exits the indoor metering device 112 and flows to the outdoor metering device 120, which may meter the flow of refrigerant through the outdoor metering device 120, such that the refrigerant downstream of the outdoor metering device 120 is at a lower pressure than the refrigerant upstream of the outdoor metering device 120. From the outdoor metering device 120, the refrigerant may enter the outdoor heat exchanger 114. As the refrigerant is passed through the outdoor heat exchanger 114, heat may be transferred to the refrigerant from an airflow that is passed through and/or into contact with the outdoor heat exchanger 114 by the outdoor fan 118. Refrigerant leaving the outdoor heat exchanger 114 may flow to the second variable port 134 of the reversing valve 122, where the reversing valve 122 may be selectively configured to divert the refrigerant to exit the reversing valve 122 through the first outlet port 132 and consequently back to the compressor 116, where the refrigeration cycle may begin again.

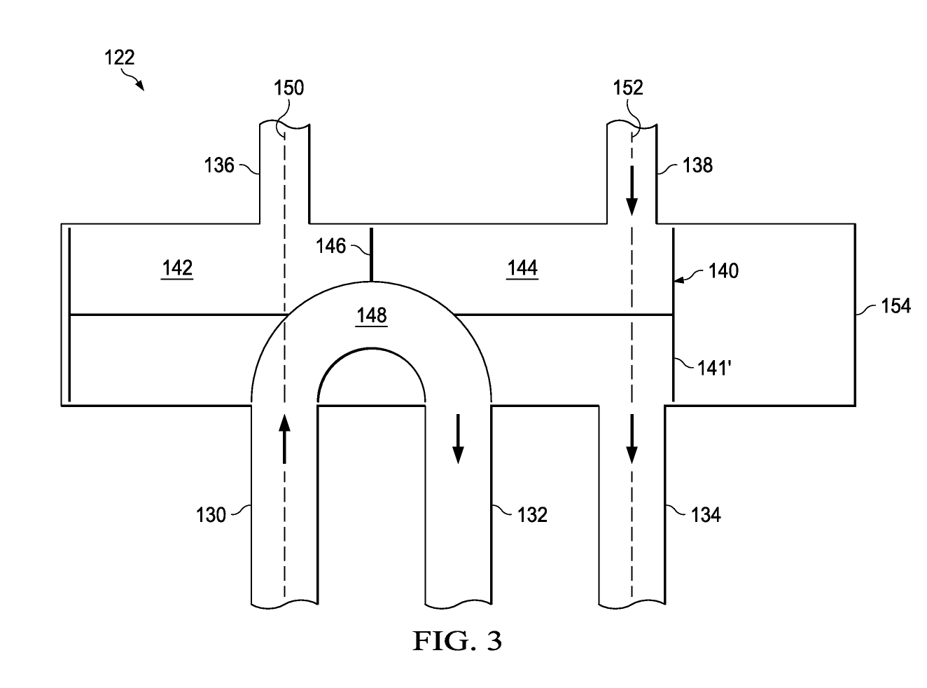

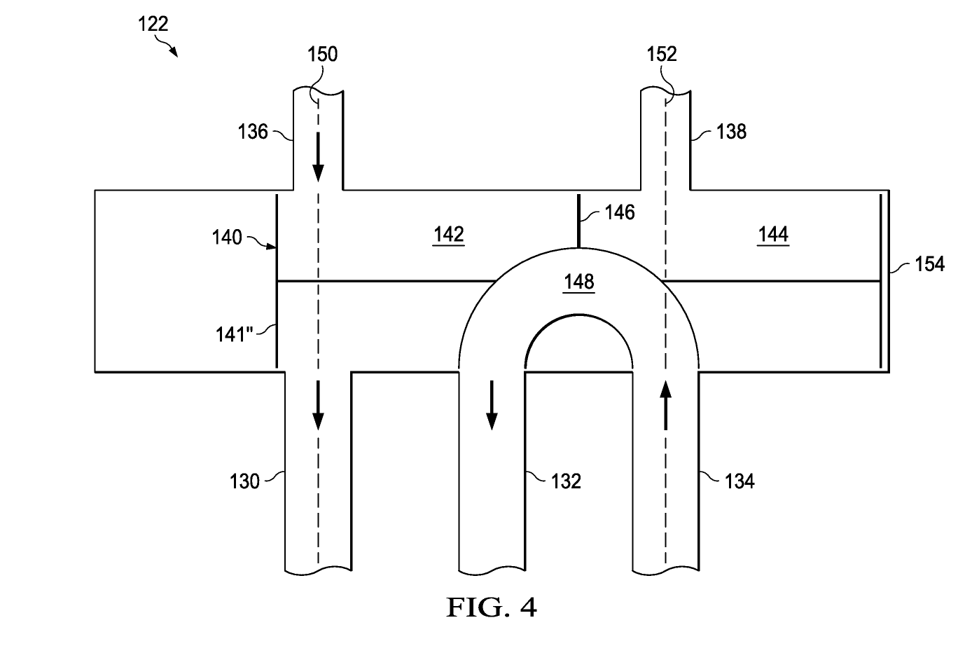

Referring now to FIGS. 3 and 4, a schematic diagram of the five-way reversing valve 122 of FIGS. 1-2 is shown configured for operation in the cooling mode and configured for operation in the heating mode, respectively, according to embodiments of the disclosure. The reversing valve 122 may generally comprise a first variable port 130, a first outlet port 132, a second variable port 134, a first inlet port 136, and a second inlet port 138 that extend from a central housing 154. In some embodiments, the first inlet port 136 and the second inlet port 138 may extend from the central housing 154 in substantially the same direction, while the first variable port 130, the first outlet port 132, and the second variable port 134 extend from the central housing 154 in a substantially opposing direction. Additionally, in some embodiments, the first inlet port 136 may be substantially coaxially aligned with the first variable port 130 along a first axis 150, while the second inlet port 138 may be substantially coaxially aligned with the second variable port 134 along a second axis 152. In some embodiments, substantially coaxially aligning the first inlet port 136 with the first variable port 130 and substantially coaxially aligning the second inlet port 138 with the second variable port 134 may reduce a high pressure side pressure differential as compared to traditional four-way reversing valves.

The reversing valve 122 may also comprise a selectively movable shuttle 140. The shuttle 140 may be housed within the central housing 154 and be configured to selectively move laterally within the central housing 154 to alter the flowpaths through the reversing valve 122. The shuttle 140 may also be configured to selectively remove a component, i.e. the desuperheater heat exchanger 124, from the high pressure side of the refrigerant fluid circuit when used in HVAC system 100 of FIGS. 1-2. In some embodiments, the position of the shuttle 140 may be selectively controlled by the outdoor controller 103 of the outdoor unit 104 and/or the system controller 106. In other embodiments, the position of the shuttle 140 may be selectively controlled by admitting high pressure gas to at least one of a left end and right end of the central housing 154 of the reversing valve 122. The shuttle 140 may generally comprise a first interior space 142 and a second interior space 144 that are generally separated and/or divided by a seal 146. The seal 146 may generally be configured to substantially prevent refrigerant in the first interior space 142 from passing to and/or entering the second interior space 144. Additionally, the seal 146 may also be configured to substantially prevent refrigerant in the second interior space 144 from passing to and/or entering the first interior space 142. As a result of separating the first interior space 142 from the second interior space 144, flow can be admitted to the valve via alternate high pressure inlets, 136 and 138.

In some embodiments, the second interior space 144 may form at least a portion of the fluid flowpath through the reversing valve 122 from the second inlet port 138 to the second variable port 134 when the shuttle 140 is configured in a first position 141′ and/or the reversing valve 122 is configured for operation in the cooling mode, while the first interior space 142 may form at least a portion of the fluid flowpath through the reversing valve 122 from the first inlet port 136 to the first variable port 130 when the shuttle 140 is configured in a second position 141″ and/or the reversing valve 122 is configured for operation in the heating mode. Further, the shuttle 140 may also comprise a connecting flowpath 148 that is configured to selectively connect the first variable port 130 and the first outlet port 132 in fluid communication when the shuttle 140 is in the first position 141′ and/or the reversing valve 122 is configured for operation in the cooling mode and that is configured to connect the first outlet port 132 and the second variable port 134 in fluid communication when the shuttle 140 is configured in the second position 141″ and/or the reversing valve 122 is configured for operation in the heating mode. Accordingly, it will be appreciated that two flowpaths exist concurrently through the reversing valve 122 whether the shuttle 140 is configured in the first position 141′ (cooling mode) or the second position 141″ (heating mode). Additionally, by selectively configuring the shuttle 140 in the reversing valve 122 between the first position 141′ and the second position 141″, refrigerant flow through the heat exchangers 108, 114 in addition to the role of the condenser is effectively reversed.

Referring specifically now to FIG. 3, the reversing valve 122 is configured for operation in the cooling mode of HVAC system 100. When HVAC system 100 is configured for operation in the cooling mode, the shuttle 140 may generally be configured in the first position 141′. As previously stated, when the shuttle 140 is configured in the first position 141′, refrigerant may enter the reversing valve 122 through the second inlet port 138, flow through the second interior space 144, and exit the reversing valve 122 through the second variable port 134. Accordingly, the shuttle 140 may also prevent refrigerant from entering the reversing valve 122 through the first inlet port 136, while the seal 146 may also prevent refrigerant flowing through the second interior space 144 from entering the first interior space 142. Further, when the shuttle 140 is configured in the first position 141′, the connecting flowpath 148 may connect the first variable port 130 and the first outlet port 132 in fluid communication, such that refrigerant may enter the reversing valve 122 through the first variable port 130 and flow through the connecting flowpath 148, and exit the reversing valve 122 through the first outlet port 134.

Referring specifically now to FIG. 4, the reversing valve 122 is configured for operation in the heating mode of HVAC system 100. When HVAC system 100 is configured for operation in the heating mode, the shuttle 140 may generally be configured in the second position 141″. As previously stated, when the shuttle 140 is configured in the second position 141″, refrigerant may enter the reversing valve 122 through the first inlet port 136, flow through the first interior space 142, and exit the reversing valve 122 through the first variable port 130. Accordingly, the shuttle 140 may also prevent refrigerant from entering the reversing valve 122 through the second inlet port 138, while the seal 146 may also prevent refrigerant flowing through the first interior space 142 from entering the second interior space 144. Further, when the shuttle 140 is configured in the second position 141″, the connecting flowpath 148 may connect the second variable port 134 and the first outlet port 132 in fluid communication, such that refrigerant may enter the reversing valve 122 through the second variable port 134, flow through the connecting flowpath 148, and exit the reversing valve 122 through the first outlet port 134.

It will be appreciated that the first variable port 130 and the second variable port 134 may alternatively be referred to as heat exchanger ports, since the first variable port 130 remains in fluid communication with the indoor heat exchanger 108 and the second variable port 134 remains in fluid communication with the outdoor heat exchanger 114 regardless of the position of the shuttle 140 and/or the mode of operation of the HVAC system 100. Additionally, the first outlet port 132 remains in fluid communication with a suction side of the compressor 116 regardless of the position of the shuttle 140 and/or the mode of operation of the HVAC system 100. Furthermore, the first inlet port 136 and the second inlet port 138 may also be referred to as high pressure inlet ports.

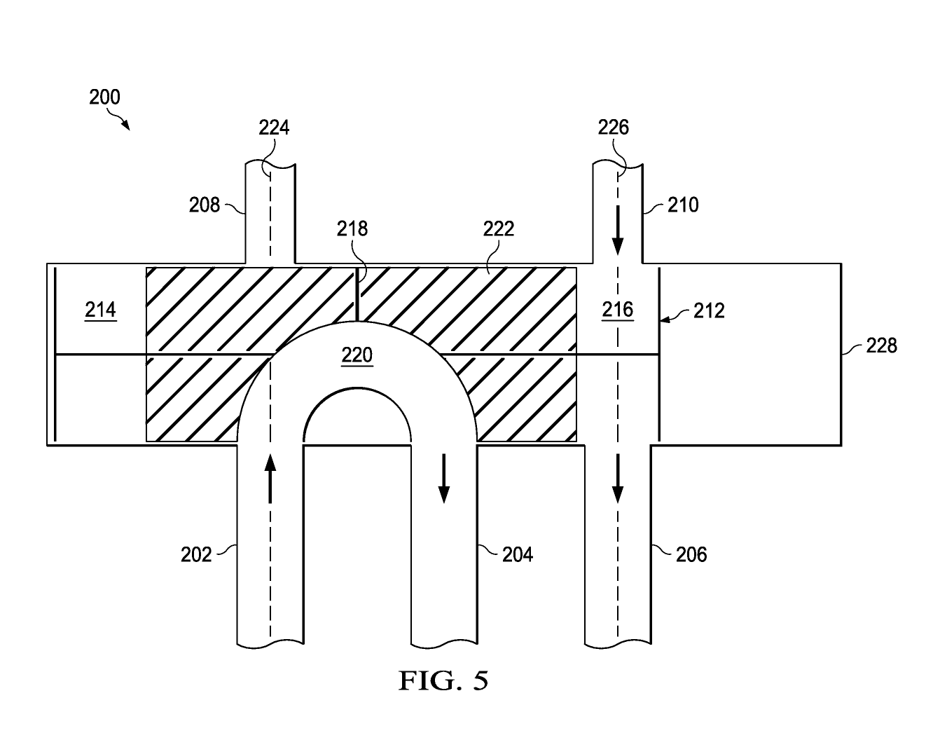

Referring now to FIG. 5, a schematic diagram of a five-way reversing valve 200 configured in the cooling mode is shown according to another embodiment of the disclosure. Reversing valve 200 may be substantially similar to reversing valve 122 of FIGS. 1-4. Further, the reversing valve 200 may also be configured to operate substantially similar to reversing valve 122 in each of a cooling mode associated with a first shuttle position and a heating mode associated with a second shuttle position. Reversing valve 200 may generally comprise a first variable port 202, a first outlet port 204, a second variable port 206, a first inlet port 208, and a second inlet port 210 that extend from a central housing 228. The first inlet port 208 may be substantially coaxially aligned with the first variable port 202 along a first axis 224, while the second inlet port 210 may be substantially coaxially aligned with the second variable port 206 along a second axis 226. Reversing valve 200 may also generally comprise a shuttle 212, a first interior space 214, a second interior space 216, a seal 218, and a connecting flowpath 220.

However, reversing valve 200 may also comprise an insulating material 222. The insulating material 222 may be substantially disposed within the shuttle 212 between the first interior space 214 and the second interior space 216. The insulating material 222 may also substantially envelope and/or be disposed substantially around the connecting flowpath 220. Accordingly, the insulating material 222 may be disposed between the connecting flowpath 220 and each of the first interior space 214 and the second interior space 216. In some embodiments, the insulating material 222 may reduce the amount of heat transfer between a high pressure flowpath (from second inlet port 210 to second variable port 206 in cooling mode; from first inlet port 208 to first variable port 202 in heating mode) and a low pressure flowpath (from first variable port 202 to first outlet port 204 in cooling mode; from second variable port 206 to first outlet port 204 in heating mode). By reducing the heat transfer between flowpaths in the reversing valve 200, the efficiency of an HVAC system, such as HVAC system 100 of FIGS. 1-2, that may utilize reversing valve 200, may be increased over a traditional four-way reversing valve and/or a five-way reversing valve without insulating material 222.

In some embodiments, the insulating material 222 may also form the seal 218 that separates the first interior space 214 from the second interior space 216 in addition to reducing the heat transfer between flowpaths through the reversing valve 200. Additionally, the first interior space 214 and the second interior space 216 may be formed as short, cylindrically-shaped and/or tubular flowpaths that extend through the shuttle 212. In some embodiments, configuring the first interior space 214 and the second interior space 216 as substantially cylindrically-shaped and/or tubular flowpaths through the shuttle 212 may reduce expansion and contraction losses through the reversing valve 200 as compared to other expansion valves that have non-linear flowpaths. Accordingly, reversing valve 200 may increase the efficiency of an HVAC system, such as HVAC system 100, that utilizes reversing valve 200, by eliminating and/or reducing the pressure differential across the reversing valve 200 and/or the heat transfer between adjacent flowpaths. Furthermore, it will be appreciated that while the shuttle 212 of the reversing valve 200 is shown configured in a position substantially similar to the first position 141′ of reversing valve 122 shown in FIG. 3 that is associated with a cooling mode HVAC system 100, shuttle 212 of the reversing valve 200 may also be configured in a position substantially similar to the second position 141″ of reversing valve 122 shown in FIG. 4 that is associated with a heating mode HVAC system 100.

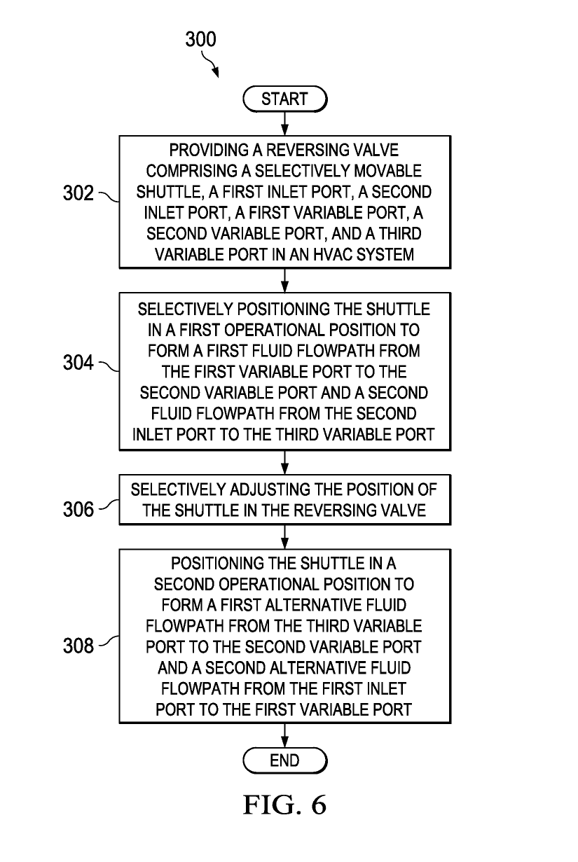

Referring now to FIG. 6, a flowchart of a method 300 of operating an HVAC system is shown according to an embodiment of the disclosure. The method 300 may begin by providing a five-way reversing valve comprising a selectively movable shuttle, a first high pressure inlet port, a second high pressure inlet port, a first variable port, a first outlet port, and a second variable port in an HVAC system. In some embodiments, the five-way reversing valve may be reversing valve 122 of FIGS. 1-4. In other embodiments, the five-way reversing valve may be reversing valve 200 of FIG. 5. The method 300 may continue at block 304 by selectively positioning the shuttle in a first operational position to form a first fluid flowpath from the first variable port to the first outlet port and a second fluid flowpath from the second inlet port to the second variable port. In some embodiments, the first operational position may be associated with a cooling mode of the HVAC system. The method 300 may continue at block 306 by selectively adjusting the position of the shuttle. In some embodiments, the selectively adjusting the shuttle may be accomplished by selectively controlling a solenoid and/or relay associated with the reversing valve. In some embodiments, the selectively adjusting the shuttle may be accomplished by controlling the reversing valve with at least one of an outdoor controller associated with an outdoor unit of the HVAC system and/or a system controller of the HVAC system. The method 300 may continue at block 308 by positioning the shuttle in a second operational position to form a first alternative fluid flowpath from the second variable port to the first outlet port and a second alternative fluid flowpath from the first inlet port to the first variable port. In some embodiments, the second operational position may be associated with a heating mode of the HVAC system.

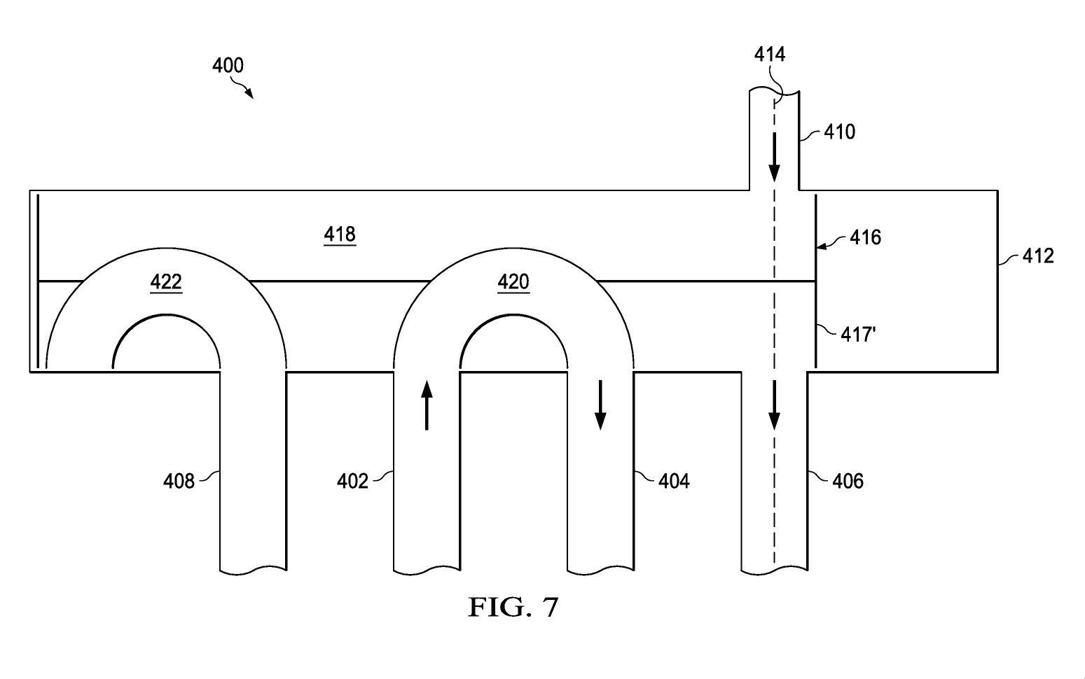

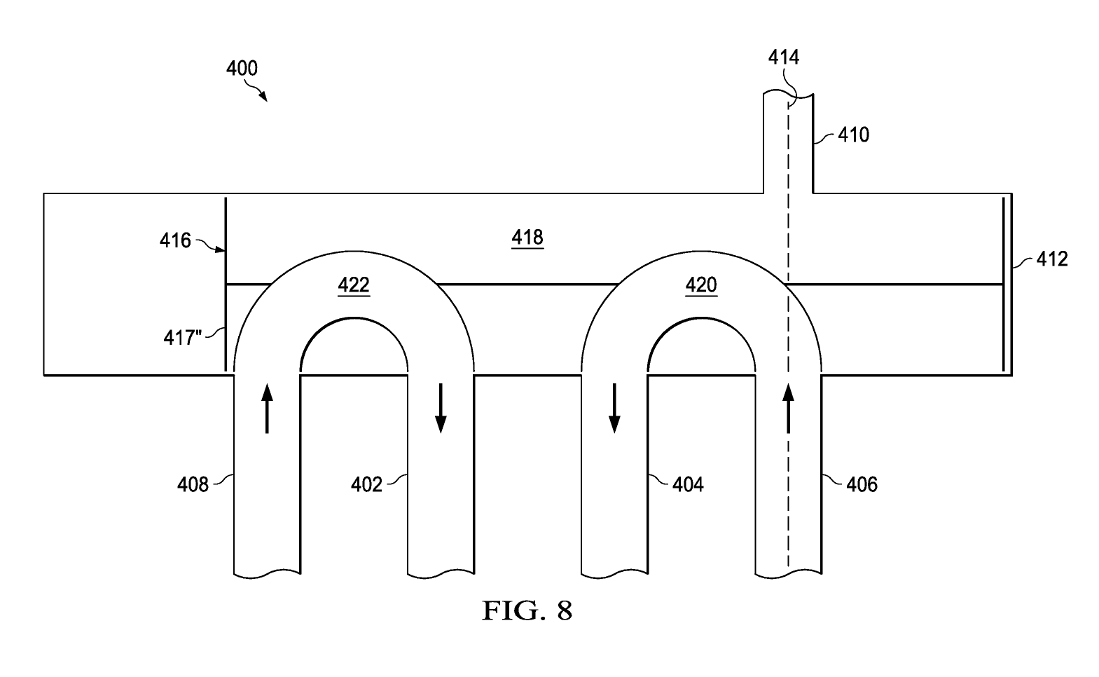

Referring now to FIGS. 7 and 8, a schematic diagram of a five-way reversing valve 400 configured in the cooling mode and heating mode, respectively, are shown according to yet another embodiment of the disclosure. The reversing valve 400 may generally be substantially similar to the reversing valve 122 of FIGS. 1-4 and comprise a first variable port 402, a first outlet port 404, a second variable port 406, a first inlet port 408, and a second inlet port 410 that extend from a central housing 412. Additionally, the reversing valve 400 may be configured for use in HVAC system 100 of FIGS. 1-2 so that the first variable port 402, first outlet port 404, second variable port 406, first inlet port 408, and second inlet port 410 of reversing valve 400 may be configured and/or connected to components of HVAC system 100 in a substantially similar manner to the first variable port 130, first outlet port 132, second variable port 134, first inlet port 136, and second inlet port 138, respectively, of reversing valve 122 of FIGS. 1-4. However, the first inlet port 408 on reversing valve 400 may extend from the central housing 412 in substantially the same direction as the first variable port 402, the first outlet port 404, and the second variable port 406 and in a substantially opposite direction from the second inlet port 410. Additionally, in some embodiments, the second inlet port 410 may be substantially coaxially aligned with the second variable port 406 along an axis 414. In some embodiments, substantially coaxially aligning the second inlet port 410 with the second variable port 406 may reduce a high pressure side pressure differential as compared to traditional four-way reversing valves.

The reversing valve 400 may also comprise a selectively movable shuttle 416. The shuttle 416 may be housed within the central housing 412 and be configured to selectively move laterally within the central housing 412 to alter the flowpaths through the reversing valve 400. The shuttle 416 may also be configured to selectively remove a component, i.e. the desuperheater heat exchanger 124, from the high pressure side of the refrigerant fluid circuit when used in HVAC system 100 of FIGS. 1-2. In some embodiments, the position of the shuttle 416 may be selectively controlled by the outdoor controller 103 of the outdoor unit 104 and/or the system controller 106 of HVAC system 100 of FIGS. 1-2. In other embodiments, the position of the shuttle 416 may be selectively controlled by admitting high pressure gas to at least one of a left end and right end of the central housing 412 of the reversing valve 400. In some embodiments, an interior space 418 may form at least a portion of the fluid flowpath through the reversing valve 400 from the second inlet port 410 to the second variable port 406 when the shuttle 416 is configured in a first position 417′ and/or the reversing valve 400 is configured for operation in the cooling mode, while the interior space 418 may not receive any fluid flow when the shuttle 416 is configured in a second position 417″ and/or the reversing valve 400 is configured for operation in the heating mode.

Further, the shuttle 416 may also comprise a first connecting flowpath 420 and a second connecting flowpath 422. The first connecting flowpath 420 is configured to selectively connect the first variable port 402 and the first outlet port 404 in fluid communication when the shuttle 416 is in the first position 417′ and/or the reversing valve 400 is configured for operation in the cooling mode and is configured to connect the first outlet port 404 and the second variable port 406 in fluid communication when the shuttle 416 is configured in the second position 417″ and/or the reversing valve 400 is configured for operation in the heating mode. The second connecting flowpath 422 is configured to selectively restrict and/or prevent fluid flow through the first inlet port 408 when the shuttle 416 is in the first position 417′ and/or the reversing valve 400 is configured for operation in the cooling mode and is configured to connect the first inlet port 408 and the first variable port 402 in fluid communication when the shuttle 416 is configured in the second position 417″ and/or the reversing valve 400 is configured for operation in the heating mode. Accordingly, it will be appreciated that two flowpaths exist concurrently through the reversing valve 400 whether the shuttle 416 is configured in the first position 417′ (cooling mode) or the second position 417″ (heating mode). Additionally, by selectively configuring the shuttle 416 in the reversing valve 400 between the first position 417′ and the second position 417″, refrigerant flow through the heat exchangers 108, 114 of FIGS. 1-2 in addition to the role of the condenser is effectively reversed.

Referring specifically now to FIG. 7, the reversing valve 400 is configured for operation in the cooling mode of HVAC system 100. When HVAC system 100 is configured for operation in the cooling mode, the shuttle 416 may generally be configured in the first position 417′. As previously stated, when the shuttle 416 is configured in the first position 417′, refrigerant may enter the reversing valve 400 through the second inlet port 410, flow through the interior space 418, and exit the reversing valve 400 through the second variable port 406. Accordingly, the shuttle 416 may also prevent refrigerant from entering the reversing valve 400 through the first inlet port 408 and/or passing through the second connecting flowpath 422. Further, when the shuttle 416 is configured in the first position 417′, the first connecting flowpath 420 may connect the first variable port 402 and the first outlet port 404 in fluid communication, such that refrigerant may enter the reversing valve 400 through the first variable port 402 and flow through the first connecting flowpath 420, and exit the reversing valve 400 through the first outlet port 404.

Referring specifically now to FIG. 8, the reversing valve 400 is configured for operation in the heating mode of HVAC system 100. When HVAC system 100 is configured for operation in the heating mode, the shuttle 416 may generally be configured in the second position 417″. As previously stated, when the shuttle 416 is configured in the second position 417″, refrigerant may enter the reversing valve 400 through the first inlet port 408, travel through the second connecting flowpath 422, and exit the reversing valve 400 through the first variable port 402. Accordingly, the shuttle 416 may also prevent refrigerant from entering the reversing valve 400 through the second inlet port 410. Further, when the shuttle 416 is configured in the second position 417″, the first connecting flowpath 420 may connect the second variable port 406 and the first outlet port 404 in fluid communication, such that refrigerant may enter the reversing valve 400 through the second variable port 406, flow through the first connecting flowpath 420, and exit the reversing valve 400 through the first outlet port 404.

It will be appreciated that the first variable port 402 and the second variable port 406 may alternatively be referred to as heat exchanger ports, since the first variable port 402 remains in fluid communication with the indoor heat exchanger 108 and the second variable port 406 remains in fluid communication with the outdoor heat exchanger 114 regardless of the position of the shuttle 416 and/or the mode of operation of the HVAC system 100. Additionally, the first outlet port 404 remains in fluid communication with a suction side of the compressor 116 regardless of the position of the shuttle 416 and/or the mode of operation of the HVAC system 100. Furthermore, the first inlet port 408 and the second inlet port 410 may also be referred to as high pressure inlet ports.

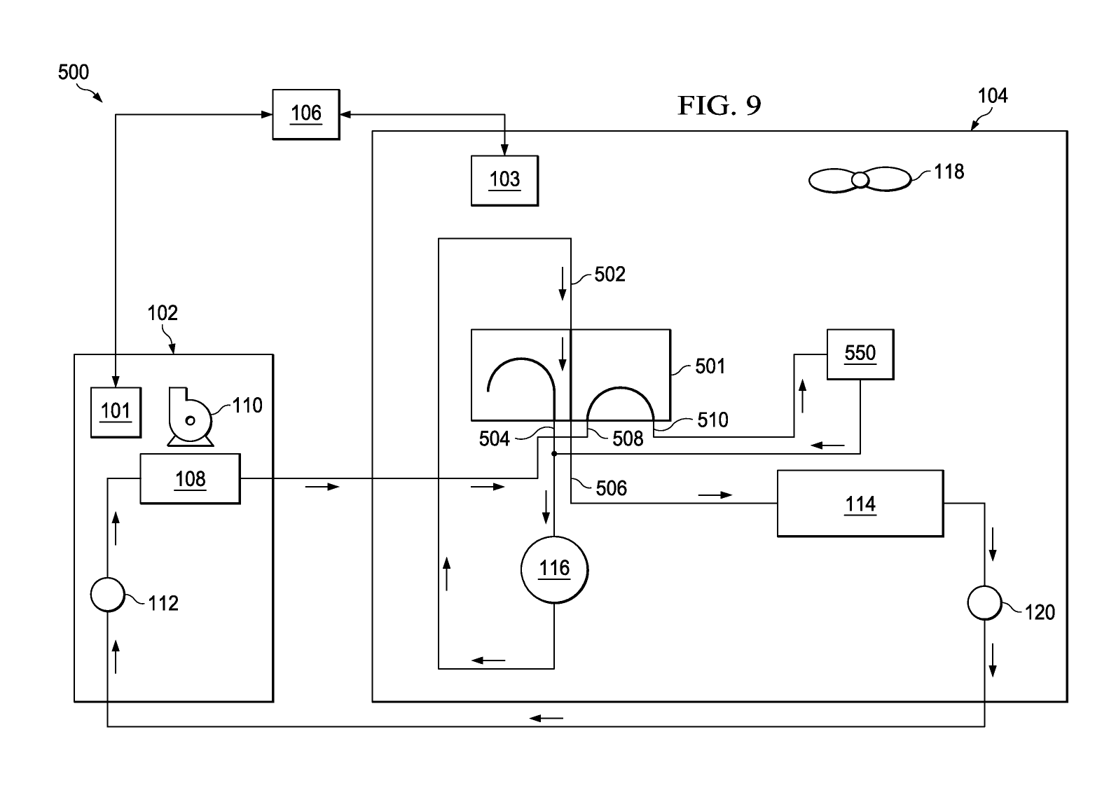

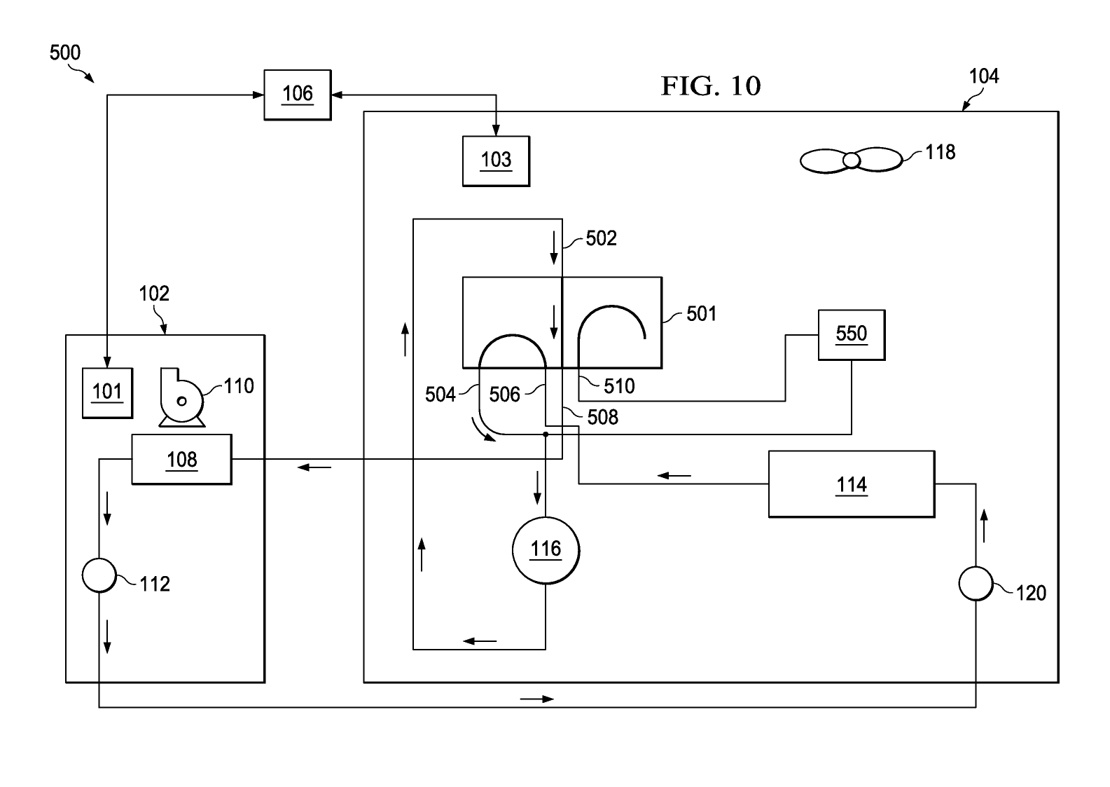

Referring now to FIGS. 9-10, a schematic diagram of an HVAC system 500 comprising a five-way reversing valve 501 configured in a cooling mode and a heating mode, respectively, are shown according to an alternative embodiment of the disclosure. HVAC system 500 may generally be substantially similar to HVAC system 100 of FIGS. 1-2 and comprise: an indoor unit 102 having an indoor controller 101, an indoor heat exchanger 108, and indoor fan 110, and an indoor metering device 112; and an outdoor unit 104 having an outdoor controller 103, an outdoor heat exchanger 114, a compressor 116, an outdoor fan 118, and an outdoor metering device 120; and a system controller 106. However, HVAC system 500 comprises a five-way reversing valve 501 that may be selectively controlled in a manner substantially similar to that of reversing valve 501 of HVAC system 100 of FIGS. 1-2 to alter a flowpath of refrigerant in the HVAC system 500 by selectively altering a refrigerant flowpath through the reversing valve 501. However, reversing valve 501 may generally be configured to alter the flowpath of refrigerant through HVAC system 500 to remove a component 550 from a low pressure side of the refrigerant fluid circuit.

Reversing valve 501 generally comprises an inlet port 502 coupled and/or connected in fluid communication to a discharge side of the compressor 116, a first suction line port 504, an outdoor heat exchanger port 506 coupled and/or connected in fluid communication to the outdoor heat exchanger 114, an indoor heat exchanger port 508 coupled and/or connected in fluid communication to the indoor heat exchanger 108, and a second suction line port 510. When the reversing valve 501 and/or the HVAC system 500 is configured for operation in the cooling mode as shown in FIG. 9, refrigerant from the compressor 116 may enter the reversing valve 501 through the inlet port 502 and exit the reversing valve 501 through the outdoor heat exchanger port 506 before flowing to the outdoor heat exchanger 114. Refrigerant may return to the reversing valve 501 from the indoor heat exchanger 108 through the indoor heat exchanger port 508 and be diverted through the second suction line port 510 to the component 550, where it may then return to the compressor 116. When the reversing valve 501 and/or the HVAC system 500 is configured for operation in the heating mode as shown in FIG. 10, refrigerant from the compressor 116 may still enter the reversing valve 501 through the inlet port 502 and exit the reversing valve 501 through the indoor heat exchanger port 508 before flowing to the indoor heat exchanger 108, effectively reversing the flow of refrigerant through the HVAC system 500. Refrigerant may return to the reversing valve 501 from the outdoor heat exchanger 114 through the outdoor heat exchanger port 506 and be diverted through the first suction line port 504 back to the compressor 116, effectively removing the component 550 from the refrigerant fluid circuit.

In embodiments where the component 550 is operable in the cooling mode, the component 550 may be coupled to the second suction line port 510 and a suction side of the compressor 116 as shown in FIG. 9, so that refrigerant received from the indoor heat exchanger 108 enters the reversing valve 501 through the indoor heat exchanger port 508 and is routed to the component 550 through the second suction line port 510. Refrigerant leaving the component 550 may thereafter return to the compressor 116. Accordingly, as shown in FIG. 10, the component 550 may be removed from the refrigerant fluid circuit when the reversing valve 501 and/or the HVAC system 500 is configured for operation in the heating mode. However, in alternative embodiments, where the component 550 is operable in the heating mode, the component 550 may be coupled to the first suction line port 504 and a suction side of the compressor 116, so that refrigerant received from the outdoor heat exchanger 114 enters the reversing valve 501 through the outdoor heat exchanger port 506 and is routed to the component 550 through the first suction line port 504. Refrigerant leaving the component 550 may thereafter return to the compressor 116. Accordingly, in such alternative embodiments, the component 550 may be removed from the refrigerant fluid circuit when the reversing valve 501 and/or the HVAC system 500 is configured for operation in the cooling mode.

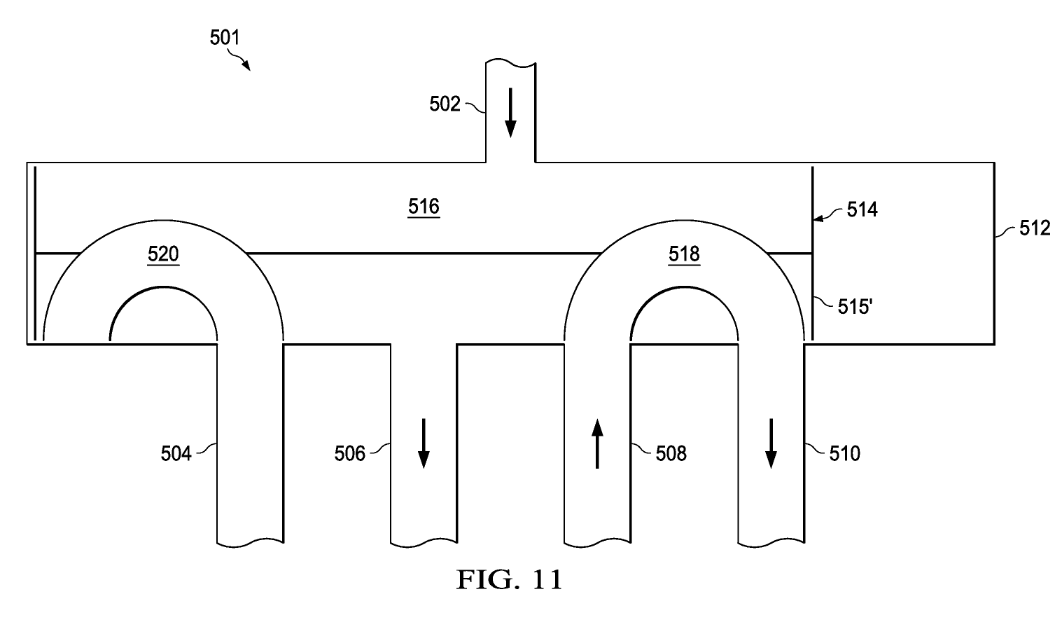

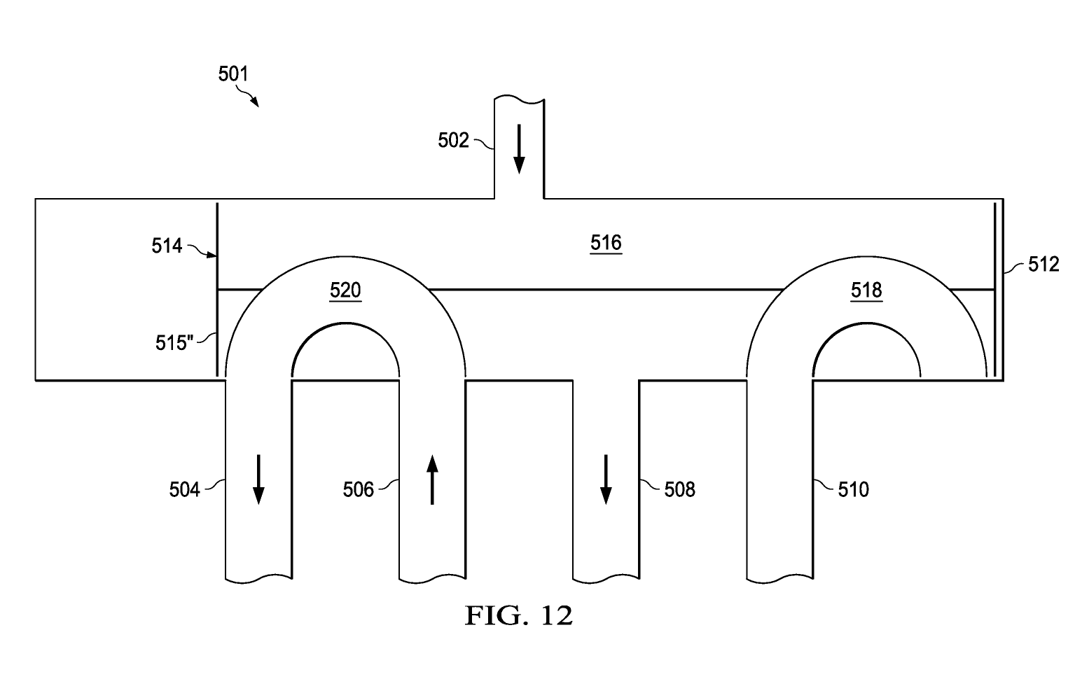

Referring now to FIGS. 11 and 12, a schematic diagram of the five-way reversing valve 501 of FIGS. 9-10 configured in the cooling mode and heating mode, respectively, are shown according to an alternative embodiment of the disclosure. Reversing valve 501 may generally be substantially similar to reversing valve 400 of FIGS. 7-8 and comprise an inlet port 502, a first suction line port 504, an outdoor heat exchanger port 506, an indoor heat exchanger port 508, and a second suction line port 510 that are substantially similar to the first variable port 402, first outlet port 404, second variable port 406, first inlet port 408, and second inlet port 410 of reversing valve 400 of FIGS. 7-8. However, as opposed to reversing valve 400, reversing valve 501 may generally be configured to remove a component from a low pressure side of the refrigerant fluid circuit of an HVAC system 500. Additionally, the inlet port 502 may also be disposed substantially between the outdoor heat exchanger port 506 and the indoor heat exchanger port 508.

The reversing valve 501 may also comprise a selectively movable shuttle 514. The shuttle 514 may be housed within a central housing 512 and be configured to selectively move laterally within the central housing 512 to alter the flowpaths through the reversing valve 501. The shuttle 514 may also be configured to selectively remove a component, i.e. component 550, from the low pressure side of the refrigerant fluid circuit when used in HVAC system 500 of FIGS. 9-10. In some embodiments, the position of the shuttle 514 may be selectively controlled by the outdoor controller 103 of the outdoor unit 104 and/or the system controller 106 of HVAC system 500 of FIGS. 9-10. In other embodiments, the position of the shuttle 514 may be selectively controlled by admitting high pressure gas to at least one of a left end and right end of the central housing 512 of the reversing valve 501. In some embodiments, an interior space 516 may form at least a portion of the fluid flowpath through the reversing valve 501 from the inlet port 502 to the outdoor heat exchanger port 506 when the shuttle 514 is configured in a first position 515′ and/or the reversing valve 501 is configured for operation in the cooling mode, while the interior space 516 may form at least a portion of the fluid flowpath through the reversing valve 501 from the inlet port 502 to the indoor heat exchanger port 508 when the shuttle 514 is configured in a second position 515″ and/or the reversing valve 501 is configured for operation in the heating mode.

Further, the shuttle 514 may also comprise a first connecting flowpath 518 and a second connecting flowpath 520. The first connecting flowpath 518 is configured to selectively connect the indoor heat exchanger port 508 and the second suction line port 510 in fluid communication when the shuttle 514 is in the first position 515′ and/or the reversing valve 501 is configured for operation in the cooling mode and may prevent fluid flow through the reversing valve 501 when the shuttle 514 is configured in the second position 515″ and/or the reversing valve 501 is configured for operation in the heating mode. The second connecting flowpath 520 is configured to selectively restrict and/or prevent fluid flow through the first suction line port 504 when the shuttle 514 is in the first position 515′ and/or the reversing valve 501 is configured for operation in the cooling mode and may prevent fluid flow through the reversing valve 501 when the shuttle 514 is configured in the second position 515″ and/or the reversing valve 501 is configured for operation in the heating mode. Accordingly, it will be appreciated that two flowpaths exist concurrently through the reversing valve 501 whether the shuttle 514 is configured in the first position 515′ (cooling mode) or the second position 515″ (heating mode). Additionally, by selectively configuring the shuttle 514 in the reversing valve 501 between the first position 515′ and the second position 515″, refrigerant flow through the heat exchangers 108, 114 of FIGS. 9-10 in addition to the role of the condenser is effectively reversed.

Referring specifically now to FIG. 11, the reversing valve 501 is configured for operation in the cooling mode of HVAC system 500. When HVAC system 500 is configured for operation in the cooling mode, the shuttle 514 may generally be configured in the first position 515′. As previously stated, when the shuttle 514 is configured in the first position 515′, refrigerant may enter the reversing valve 501 through the inlet port 502, flow through the interior space 516, and exit the reversing valve 501 through the outdoor heat exchanger port 506. Accordingly, the shuttle 514 may also prevent refrigerant from entering the reversing valve 501 through the first suction line port 504 and/or passing through the second connecting flowpath 520. Further, when the shuttle 514 is configured in the first position 515′, the first connecting flowpath 518 may connect the indoor heat exchanger port 508 and the second suction line port 510 in fluid communication, such that refrigerant may enter the reversing valve 501 through the indoor heat exchanger port 508 and flow through the first connecting flowpath 518, and exit the reversing valve 501 through the second suction line port 510.

Referring specifically now to FIG. 12, the reversing valve 501 is configured for operation in the heating mode of HVAC system 500. When HVAC system 500 is configured for operation in the heating mode, the shuttle 514 may generally be configured in the second position 515″. As previously stated, when the shuttle 514 is configured in the second position 515″, refrigerant may enter the reversing valve 501 through the inlet port 502, flow through the interior space 516, and exit the reversing valve 501 through the indoor heat exchanger port 508, effectively reversing the fluid flow of refrigerant through the HVAC system 500. Accordingly, the shuttle 514 may also prevent refrigerant from entering the reversing valve 501 through the second suction line port 510 and/or passing through the first connecting flowpath 518. Further, when the shuttle 514 is configured in the second position 515″, the second connecting flowpath 520 may connect the outdoor heat exchanger port 506 and the first suction line port 504 in fluid communication, such that refrigerant may enter the reversing valve 501 through the outdoor heat exchanger port 506, flow through the second connecting flowpath 520, and exit the reversing valve 501 through the first suction line port 504.

It will be appreciated that the outdoor heat exchanger port 506 and the indoor heat exchanger port 508 remain in fluid communication with the outdoor heat exchanger 114 and the indoor heat exchanger 108, respectively, regardless of the position of the shuttle 514 and/or the mode of operation of the HVAC system 500. Additionally, the inlet port 502 remains in fluid communication with a discharge side of the compressor 116 regardless of the position of the shuttle 514 and/or the mode of operation of the HVAC system 500.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A reversing valve, comprising:
a selectively movable shuttle;
a first high pressure inlet port;
a second high pressure inlet port;
a first variable port;
a first outlet port; and
a second variable port.

2. The reversing valve of claim 1, wherein at least one of the first high pressure inlet port and the second high pressure inlet port is coaxially aligned with at least one of the first variable port and the second variable port.

3. The reversing valve of claim 1, wherein the shuttle is configured to provide a first fluid flowpath from the first variable port to the first outlet port when the shuttle is configured in a first operational position.

4. The reversing valve of claim 3, wherein the shuttle is configured to provide a second fluid flowpath from the second inlet port to the second variable port when the shuttle is configured in the first operational position.

5. The reversing valve of claim 4, wherein the shuttle is configured to provide a first alternative fluid flowpath from the second variable port to the first outlet port when the shuttle is configured in a second operational position.

6. The reversing valve of claim 5, wherein the shuttle is configured to provide a second alternative fluid flowpath from the first inlet port to the first variable port when the shuttle is configured in the second operational position.

7. A heating, ventilation, and/or air conditioning (HVAC) system, comprising:
a reversing valve comprising:
a selectively movable shuttle;
a first high pressure inlet port;
a second high pressure inlet port;
a first variable port;
a first outlet port; and
a second variable port.

8. The HVAC system of claim 7, wherein at least one of the first high pressure inlet port and the second high pressure inlet port is coaxially aligned with at least one of the first variable port and the second variable port.

9. The HVAC system of claim 7, wherein the shuttle is configured to provide a first fluid flowpath from the first variable port to the first outlet port when the shuttle is configured in a first operational position.

10. The HVAC system of claim 9, wherein the shuttle is configured to provide a second fluid flowpath from the second inlet port to the second variable port when the shuttle is configured in the first operational position.

11. The HVAC system of claim 10, wherein the shuttle is configured to allow fluid flow through a secondary heat exchanger component when the shuttle is configured in the first operational position.

12. The HVAC system of claim 10, wherein the first operational position is associated with a cooling mode of an HVAC system.

13. The HVAC system of claim 10, wherein the shuttle is configured to provide a first alternative fluid flowpath from the second variable port to the first outlet port when the shuttle is configured in a second operational position.

14. The HVAC system of claim 13, wherein the shuttle is configured to provide a second alternative fluid flowpath from the first inlet port to the first variable port when the shuttle is configured in the second operational position.

15. The HVAC system of claim 14, wherein the shuttle is configured to remove a secondary heat exchanger component from a refrigerant fluid circuit of the HVAC system when the shuttle is configured in the second operational position.

16. The HVAC system of claim 14, wherein the second operational position is associated with a heating mode of an HVAC system.

17. A method of operating a heating, ventilation, and/or air conditioning (HVAC) system, comprising:
providing a reversing valve comprising a selectively movable shuttle, a first inlet port, a second inlet port, a first variable port, a first outlet port, and a second variable port in an HVAC system;
selectively positioning the shuttle in a first operational position to form a first fluid flowpath from the first variable port to the first outlet port and a second fluid flowpath from the second inlet port to the second variable port;
selectively adjusting the position of the shuttle in the reversing valve; and
positioning the shuttle in a second operational position to form a first alternative fluid flowpath from the second variable port to the first outlet port and a second alternative fluid flowpath from the first inlet port to the first variable port.

18. The method of claim 16, further comprising:
removing a secondary heat exchanger component from a refrigerant fluid circuit of the HVAC system when the shuttle is configured in the second operational position.

19. The method of claim 17, wherein the first operational position is associated with a cooling mode of the HVAC system, and wherein the second operational position is associated with a heating mode of the HVAC system.

20. The method of claim 17, wherein the selectively adjusting the shuttle is accomplished by controlling the reversing valve with at least one of an outdoor controller of an outdoor unit of the HVAC system and a system controller of the HVAC system.
